(19) United States
(12) Patent Application Publication
(10) Pub. No.: US 2011/0171851 A1
(43) Pub. Date: Jul. 14, 2011

(54) FLAT CIRCUIT BODY

(75) Inventors: Yuuya KISHIBATA, Makinohara (JP); Tomohiro SHIMADA, Makinohara (JP); Yasufumi SHIBATA, Toyota (JP); Takashi NOMURA, Toyota (JP)

(73) Assignees: YAZAKI CORPORATION, Tokyo (JP); TOYOTA JIDOSHA KABUSHIKI KAISHA, Toyota-shi (JP)

(21) Appl. No.: 13/004,634

(22) Filed: Jan. 11, 2011

(30) Foreign Application Priority Data
Jan. 14, 2010 (JP) 2010-005574

(51) Int. Cl. H01R 4/24

(52) U.S. Cl. 439/426

(57) ABSTRACT

An FFC 1 as a flat circuit body includes a plurality of flat-plate-shaped electrodes 41 arranged with gaps between them at an end of the FFC 1, and configured to contact terminal blades 321a of terminals 32 included in a mating connector. Further, the FFC 1 includes an electrode-insulating film 51 for covering positions which do not contact the terminal blades 321a on surfaces of the electrodes 41 when the electrodes 41 and the terminal blades 321a of the terminals 32 contact each other.

### CROSS REFERENCE TO RELATED APPLICATIONS

This application is on the basis of Japanese Patent Application No. 2010-005574, the contents of which are hereby incorporated by reference.

### BACKGROUND OF THE INVENTION

1. Field of the Invention

The present invention relates to a flat circuit body such as FPC (flexible print circuit) and FFC (flexible flat cable).

2. Description of the Related Art

Various electronic devices are mounted on a vehicle. For supplying an electric power from an electric source such as a battery and a control signal from a controller to the electronic devices, a wiring harness is arranged in the vehicle. The wiring harness includes an electric wire and the like, and is connected to a connector. The connector includes: a housing made of insulating synthetic resin; and a terminal received in the housing and connected to the electric wire.

Because users want a vehicle to have multiple functions, the number of the electronic devices mounted on the vehicle is increased. In accordance with this, the number of the electric wires for connecting the electronic devices in the wiring harness is increased, a weight and a volume of the wiring harness is increased.

Therefore, as an electric wire included in the wiring harness, to use a flat circuit body such as FFC and FPC is suggested.

The flat circuit body is formed in a flat band shape and includes: a conductor having a rectangular sectional shape; and a film cover for covering the conductor. A plurality of conductors is provided on the flat circuit body. Each conductor is extended in a straight shape. The conductors are arranged parallel to each other. The cover isolates the conductors from each other. A flat-shaped terminal to be connected to the terminal of the connector is provided at an end of the conductor. By using such a flat circuit body in the wiring harness, a size and a weight of the wiring harness have been reduced.

Conventionally, the terminal of the flat circuit body has been coated with tin-lead alloy plating. However, because of the environmental reason, the use of lead is restricted, and a demand for lead free is increased. In accordance with this, the tin plating is starting to be used. However, when the terminal of the flat circuit body is covered with the tin plating, there is a problem that a whisker (a filamentary-formed single crystal) is generated to make a short-circuit between the terminals. Further, by plating gold instead of tin, the generation of whisker is prevented. However, there is another problem that the cost is increased.

A technique for solving the problems is suggested in the Patent Document 1. The FFC in the Patent Document 1 includes a conductor having a Cu₃Sn₁ (copper-tin) alloy layer on a Cu (copper) substrate, and a Cu₆Sn₅ (copper-tin) alloy layer on the Cu₃Sn₁ alloy layer. Thereby, a hardness of a conductor surface of the FFC is increased to prevent the generation of whisker on the conductor surface.

[Patent Document 1] JP, A, 2007-123209

However, in the above-described FFC, while the generation of whisker on the conductor surface is prevented, there remains a possibility to generate the whisker. Further, it is not possible to quantify the prevention of the whisker generation, and a growth rate of the generated whisker is unclear. Therefore, the solution described in the Patent Document 1 is insufficient for the whisker.

Accordingly, an object of the present invention is to provide a low-cost flat circuit body able to surely prevent a short-circuit generated by a whisker.

### SUMMERY OF THE INVENTION

In order to attain the object, according to the present invention, there is provided a flat circuit body including:
a plurality of flat electrodes arranged with gaps between them at an end of the flat circuit body and configured to contact terminals of a mating connector; and
an electrode-insulating film configured to cover a surface of the electrode other than a contact area with the terminal when the electrode contacts the terminal.

Preferably, the electrode-insulating film is formed in a manner to cover a whole surface of the electrode, and in a manner to be broken by the terminal when the terminal is pushed onto the electrode-insulating film.

Preferably, a process for electrically connecting the terminal and the electrode is processed in the electrode-insulating film.

Preferably, a slit through which the terminal penetrates is provided on the electrode-insulating film.

Preferably, an opening where the surface of the electrode is exposed along a contact area between the electrode and the terminal is provided on the electrode-insulating film.

These and other objects, features, and advantages of the present invention will become more apparent upon reading of the following detailed description along with the accompanied drawings.

### BRIEF DESCRIPTION OF THE DRAWINGS

FIG. 1 is a perspective view showing an FFC according to a first embodiment of the present invention;

FIG. 2 is a top view showing the FFC of FIG. 1;

FIG. 3 is a sectional view taken on line X-X of FIG. 2;

FIG. 4 is a sectional view showing a condition that the FFC of FIG. 1 is inserted into a connector;

FIG. 5A is a schematic view showing a condition that an electrode-insulating film of the FFC of FIG. 1 faces a terminal (terminal blade) of the connector of FIG. 3;

FIG. 5B is a schematic view showing a condition that the terminal (terminal blade) breaks through the electrode-insulating film of the FFC;

FIG. 6 is a top view showing an FFC according to a second embodiment of the present invention;

FIG. 7 is a sectional view showing a connector to which the FFC of FIG. 6 is connected;

FIG. 8A is a schematic view showing a condition that a slit of the electrode-insulating film of FIG. 6 faces the terminal (contact projection) of the connector of FIG. 7;

FIG. 8B is a schematic view showing a condition that the slit of the electrode-insulating film of the FFC is expanded by the terminal (contact projection) and the electrode and the terminal contact (conduct) each other;

FIG. 9 is a top view showing an FFC according to a third embodiment of the present invention;

FIG. 10A is a schematic view showing a condition that an opening of the electrode-insulating film of the FFC of FIG. 9 and the terminal (contact projection) of the connector of FIG. 7 are arranged in an insertion direction; and

FIG. 10B is a schematic view showing a condition that the terminal (contact projection) is fitted into the opening of the electrode-insulating film of the FFC, and the electrode and the terminal contact (conduct) each other.

### DETAILED DESCRIPTION OF THE PREFERRED EMBODIMENTS

### First Embodiment

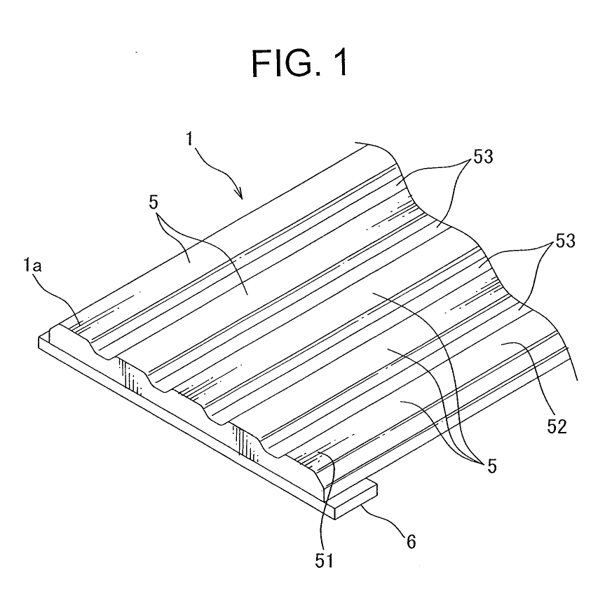

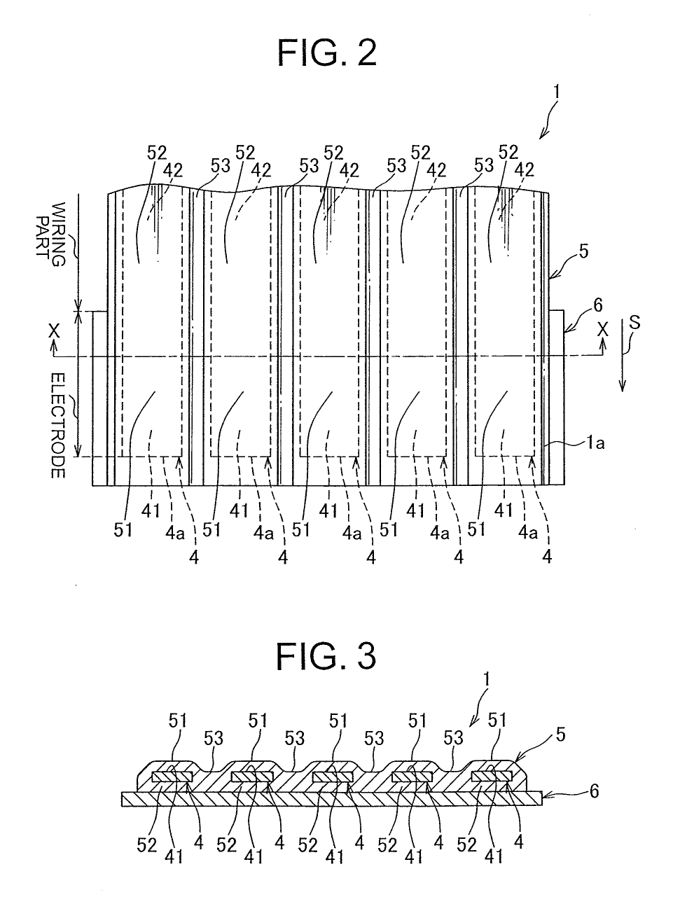

Hereinafter, an FFC 1 as a flat circuit body according to a first embodiment of the present invention will be explained with reference to FIGS. 1 to 5. When the FFC 1 is connected to a connector, electrodes provided at an end of the FFC and terminals of the connector contact each other and are electrically connected to each other, thereby electrically connect various electronic devices to each other.

As shown in FIGS. 1 to 5, the FFC (flexible flat cable) 1 as the flat circuit body includes: a plurality of flat conductors 4; a cover 5 covering the flat conductors 4; and a reinforcing member 6 provided at an end of the cover 5. The FFC 1 is formed in a flat band shape. Incidentally, the flat circuit body of the present invention may be an FPC (flexible print circuit).

The flat conductor 4 is made of conductive metal. For example, the flat conductor 4 is made of well-known flexible annealed copper material. A tin plating covers an entire surface of the flat conductor 4. The flat conductor 4 includes: a wiring part 42 made of a long straight flat plate; and a flat-plate-shaped electrode 41 provided at one end of the wiring part 42 (namely, an end 4a of the flat conductor 4). In the plurality of flat conductors 4, the wiring parts 42 are arranged parallel to each other with gaps between them, the ends 4a are aligned, and the electrodes 41 are arranged with gaps between them while surfaces of the electrodes 41 are aligned in the same direction.

The cover 5 is made of insulating synthetic resin, and formed in a band shape. The cover 5 is formed in a flat band shape, and covers the flat conductors 4 in one peace. The cover 5 isolates the conductors 4 from each other. The cover 5 includes: an electrode-insulating film 51 covering an entire surface of the electrode 41 of the flat conductor 4; a wire-insulating film 52 covering an entire surface of the wiring part 42 (namely, the whole surface of the flat conductor 4 except the electrode 41), and a groove 53 interposed between the flat conductors 4.

The electrode-insulating film 51 covers the entire surface of the electrode 41 and is formed in a thin film shape. When a later-described connector 3 is inserted into the FFC 1, and a locking member 33 of the connector 3 is locked to push a terminal blade 321a of a terminal 32 to the electrode-insulating film 51 vertically, the terminal blade 321a breaks through the electrode-insulating film 51. A material and a thickness of the electrode-insulating film 51 are determined in relation to a shape and a pushing force of the terminal blade 321a.

The wire-insulating film 52 is extended straight along the flat conductors 4, and formed in a thin film shape covering the entire surface of the wiring part 42. The wire-insulating film 52 may be thicker than the electrode-insulating film 51. The electrode-insulating film 51 and the wire-insulating film 52 are formed integrally. The groove 53 is arranged between the flat conductors 4 and parallel to the flat conductors 4, and formed in a U-sectional shape. The groove 53 is thinner than the wire-insulating film 52.

In this embodiment, the electrode-insulating film 51 is formed integrally with the wire-insulating film 52. However, the present invention is not limited to this. For example, the wire-insulating film 52 is made of insulating synthetic resin, and aside from this, the electrode-insulating film 51 is made by coating the entire surface of the electrode 41 with insulating paint. A structure of the electrode-insulating film 51 is not limited as long as the electrode-insulating film 51 is formed in a thin film shape covering the entire surface of the electrode 41, and broken through by the terminal when the terminal is pushed onto the electrode-insulating film 51 by a locking operation of the locking member of the connector.

The reinforcing member 6 is made of synthetic resin such as plastic, and formed in a rectangular plate shape. The reinforcing member 6 is firmly fixed to an end of the cover 5 (namely, the end 1a of the FFC 1) with an adhesive or the like. As shown in FIG. 3, the electrode-insulating film 51, the flat conductor 4, the wire-insulating film 52, and the reinforcing member 6 are closely overlapped with each other at the end 1a of the FFC 1. The reinforcing member 6 prevents the end 1a of the FFC 1 (namely, the electrode 41) from being deformed by an outer force or the like.

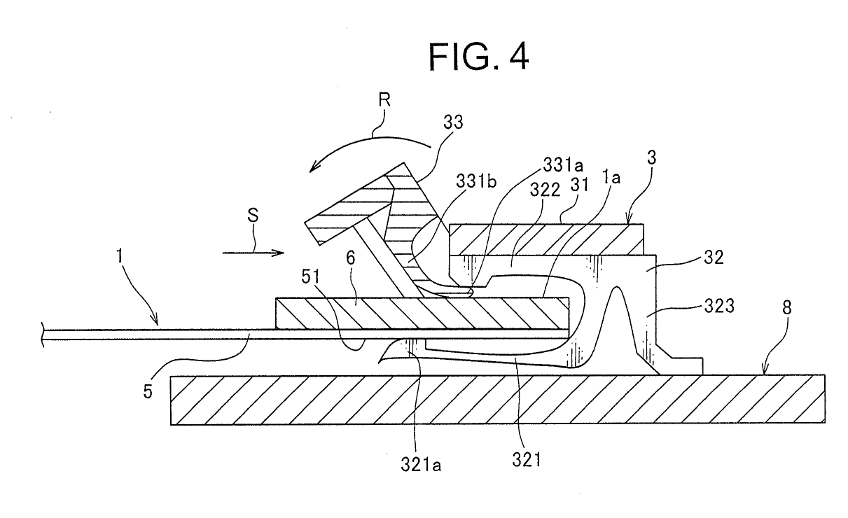

For example, the above-described FFC 1 is connected to the connector 3 shown in FIG. 4. Namely, the connector 3 is a mating connector of the FFC 1. The connector 3 is a ZIF (zero insertion force) type FFC connector such that no insertion force is needed when the FFC 1 is inserted into the connector 3. The connector 3 includes: a connector housing 31; a plurality of terminals 32 received in the connector housing and provided respectively corresponding to the electrodes 41 of the FFC 1; and a locking member for fixing the FFC 1.

The housing 31 is made of insulating synthetic resin, and formed in a rectangular tubular shape. The housing 31 supports the terminals 32 parallel to each other and with gaps between them at an inside thereof. The terminal 32 is made by punching a metal plate, and as shown in FIG. 4, includes: a pair of arms 321, 322 and a leg 323.

The pair of arms 321, 322 is extended substantially parallel to each other in the same direction. A gap between the pair of legs 321, 322 is a little bit larger than a thickness of the end 1a of the FFC 1. The end 1a of the FFC 1 is inserted into this gap. A terminal blade 321a projected toward the other arm 322 is provided on a tip end of the one arm 321. A tip end of the terminal blade 321a is formed in a sharp angle so that when the terminal blade 321a is pushed onto the electrode-insulating film 51 of the FFC 1, the terminal blade 321a breaks through the electrode-insulating film 51 and is electrically connected to the electrode 41. A shape of the terminal blade 321a is not limited as long as the terminal blade 321a breaks through the electrode-insulating film 51 when the terminal blade 321a is pushed onto the electrode-insulating film 51. For example, the tip end of the terminal blade 321a may be formed in a needle shape.

The leg 323 is formed in a substantially L-shape. A short side of the L-shape is arranged parallel to the pair of arms 321, 322, and a base end of the pair of arms 321, 322 is connected to an end of a long side of the L shape at a rear side (opposed to the shot side). The short side of the L-shape of the leg 323 is soldered on a not-shown wiring pattern formed on a print circuit board 8.

The locking member 33 is rotatably attached to the housing 31, and includes a pushing member 331 which becomes thicker as the pushing member extends from a tip end 331a to a base end 331b. As the locking member 33 is rotated and moved close to the print circuit board 8, the pushing member 331 is gradually inserted into between the pair of arms 321, 322 of the terminal 32 from the tip end 331a.

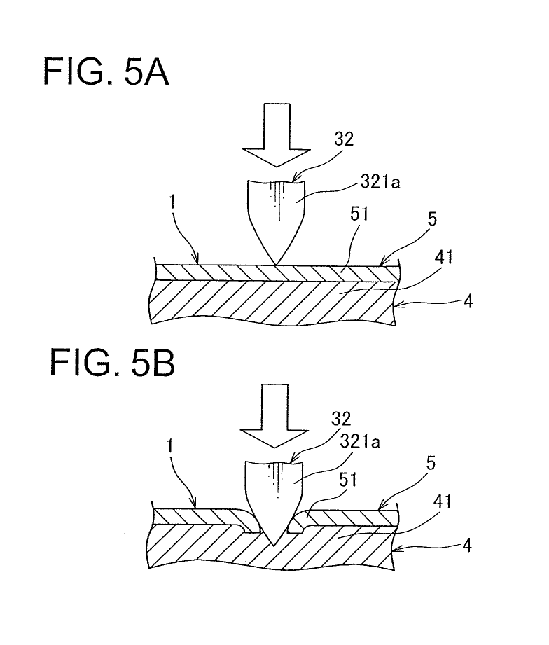

Next, an operation of the above-described FFC 1 according to the present invention will be explained with reference to FIGS. 4, 5A and 5B.

As shown in FIG. 4, when the FFC 1 is inserted into the connector 3 along an insertion direction S, the electrode-insulating film 51 and the reinforcing member 6 provided at the end 1a of the FFC 1 is positioned between the pair of arms 321, 322 of the terminal 32, and as shown in FIG. 5A, the electrode-insulating film 51 and the terminal blade 321a face each other. Then, the locking member 33 is rotated in a rotational direction R to be moved close to the print circuit board 8 (namely, the locking member 33 is locked), and the pushing member 331 is gradually inserted into between the pair of arms 321, 322 from the tip end 331a, and pushed onto between the reinforcing member 6 which is already positioned between the pair of arms 321, 322 and the other arm 322. At this time, because the pushing member 331 is formed gradually thicker as the pushing member extends from the tip end 331a to the base end 331b, as the pushing member 331 is inserted, the terminal blade 321a of the one arm 321 is relatively vertically pushed onto the electrode-insulating film 51 which is overlapped with the reinforcing member 6. Then, as shown in FIG. 5B, the terminal blade 321a breaks through the electrode-insulating film 51, and the electrode 41 of the flat conductor 4 of the FFC 1 contacts and is electrically connected to the terminal blade 321a. At this time, the electrode 41 is covered by the electrode-insulating film 51 except the contact area with the terminal blade 321a.

As described above, according to the present invention, the FFC 1 as the flat circuit body having a plurality of electrodes 41 includes the electrode-insulating film 51 covering the surface of the electrode 41 other than the contact area with the terminal 32. Therefore, when a whisker is generated in the electrode 41 of the FFC 1, the electrode-insulating film 51 prevents the whisker from extending to an adjacent electrode 41. Therefore, even when the electrode 41 is coated with a low-cost tin plating, the short-circuit caused by the whisker can be prevented.

Further, the electrode-insulating film 51 covers the entire surface of the electrode 41, and when the terminal blade 321a of the terminal 32 is pushed onto the electrode-insulating film 51, the terminal blade 321a breaks through the electrode-insulating film 51. Therefore, when the FFC 1 is connected to the connector 3, the electrode 41 and the terminal 32 surely contact each other and are electrically connected to each other. Further, only an area where the electrode 41 contacts the terminal 32 is broken, the electrode-insulating film 51 surely covers the surface of the electrode 41 other than the contact area with the terminal 32.

### Second Embodiment

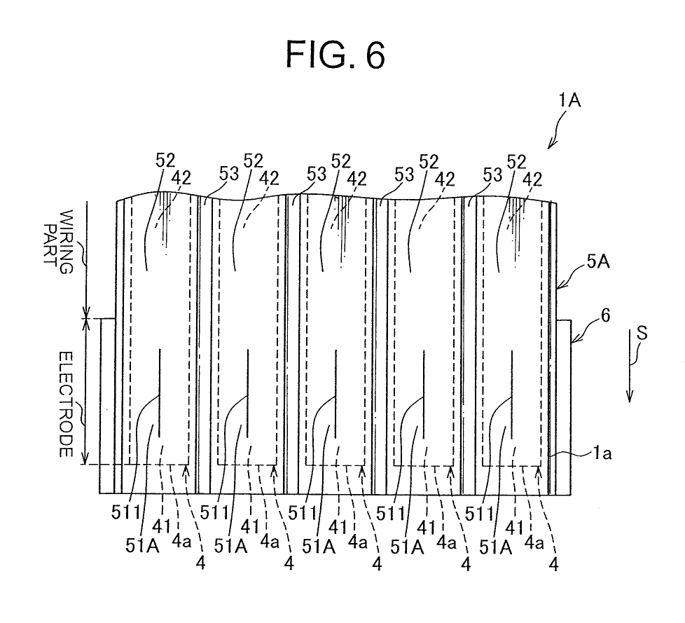

Hereinafter, an FFC 1A as a flat circuit body according to a second embodiment of the present invention will be explained with reference to FIGS. 6 to 8.

In FIGS. 6 to 8, the FFC 1A as the flat circuit body includes: a plurality of flat conductors 4; a cover 5A for covering the flat conductors 4; and a reinforcing member 6 provided at an end of the cover 5A, and is formed in a flat band shape. Incidentally, in this embodiment, the same components as the first embodiment are assigned the same reference signs and an explanation thereof is omitted.

The cover 5A is made of insulating synthetic resin, and formed in a band shape. The cover 5A is formed in a flat band shape, and covers the flat conductors 4 in one peace. The cover 5A isolates the conductors 4 from each other. The cover 5A includes: an electrode-insulating film 51A covering the entire surface of the electrode 41 of the flat conductor 4; the wire-insulating film 52 covering the entire surface of the wiring part 42 (namely, the whole surface of the flat conductor 4 except the electrode 41), and the groove 53 interposed between the flat conductors 4.

The electrode-insulating film 51A covers the entire surface of the electrode 41 and is formed in a thin film shape. A slit 511 along an insertion direction S of a later-described connector 7 is provided at the center of the electrode-insulating film 51A. This slit 511 penetrates the electrode-insulating film 51A. When a terminal 72 provided on the connector 7 pushes to expand the slit 511, the terminal 72 penetrates the electrode-insulating film 51A, and the electrode 41 and the terminal 72 are electrically connected to each other. Namely, a process for electrically connecting the terminal 72 and the electrode 41 is processed in the electrode-insulating film 51A.

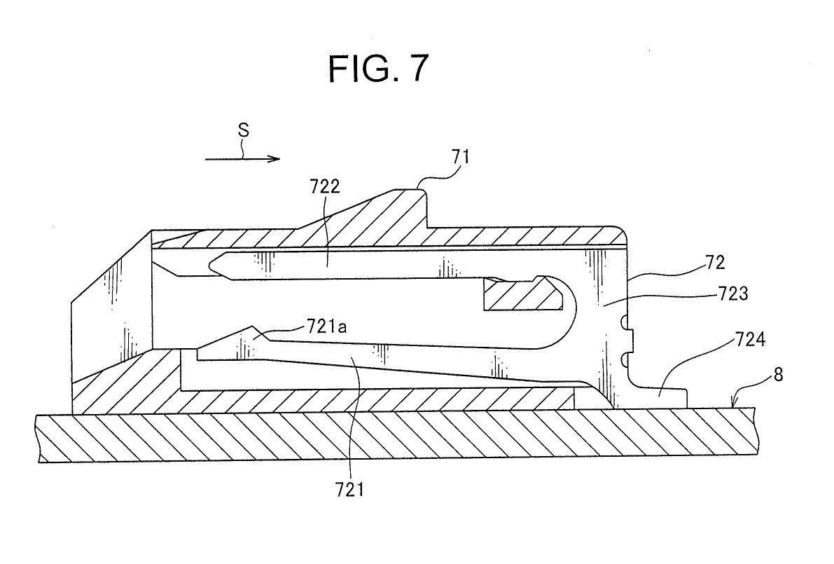

For example, the above-described FFC 1A is connected to the connector 7 shown in FIG. 7. Namely, the connector 7 is a mating connector of the FFC 1A. The connector 7 is a connector into which the FFC 1A is press-fitted, and includes: a connector housing 71; and a plurality of terminals 72 received in the housing 71 and respectively provided corresponding to the electrodes 41 of the FFC 1A. Incidentally, the FFC 1A may be connected to the connector 3 of the first embodiment as the ZIF type FFC connector.

The housing 71 is made of insulating synthetic resin, and formed in a rectangular tubular shape. The housing 71 supports the terminals 72 parallel to each other and with gaps between them at an inside thereof. The terminal 72 is made by punching a metal plate, and as shown in FIG. 7, includes: a pair of arms 721, 722; a connecting part 723 connecting the pair of arms 721, 722; and a leg 724 extended from the connecting part 723.

Tip ends of the pair of arms 721, 722 are extended substantially parallel to each other in the same direction. Base ends of the pair of arms 721, 722 are connected together by the connecting part 723. The pair of legs 721, 722 and the connecting part 723 compose a substantially C-shape. A gap between the pair of legs 721, 722 is a little bit smaller than a thickness of the end 1a of the FFC 1A. The end 1a of the FFC 1A is press-fitted into this gap. A contact projection 721a is provided on a tip end of the one arm 721. The contact projection 721a is projected toward the other end 722 so that when the contact projection 721a is pushed onto the electrode-insulating film 51A of the FFC 1A, the contact projection 721a enters the slit 511 of the electrode-insulating film 51A and is electrically connected to the electrode 41 via the electrode-insulating film 51A. The leg 724 is extended from the other arm 721 side of the connecting part 723 toward a direction opposite to an extending direction of the one arm 721. The leg 724 is soldered on a not-shown wiring pattern formed on the print circuit board 8.

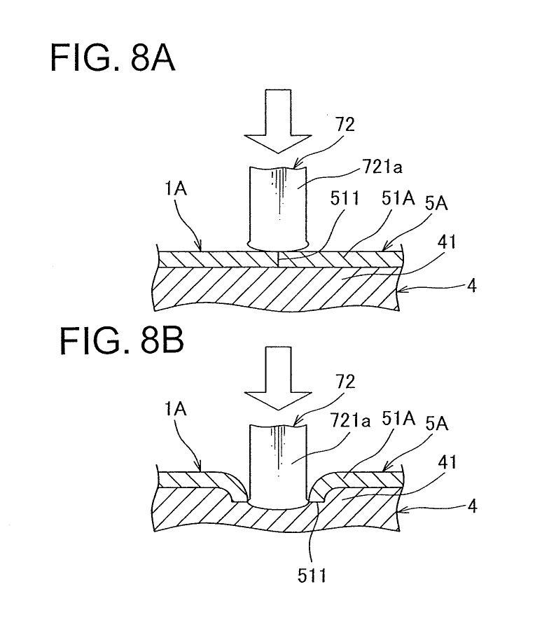

Next, an operation of the above-described FFC 1A according to the present invention will be explained with reference to FIGS. 7, 8A and 8B.

When the FFC 1A is inserted into the connector 7 along the insertion direction S, firstly, the electrode-insulating film 51A and the reinforcing member 6 provided at the end 1a of the FFC 1A is positioned between the tip ends of the pair of arms 721, 722 of the terminal 72, and as shown in FIG. 8A, the slit 511 of the electrode-insulating film 51A and the contact projection 721a contact each other. Then, when the FFC 1A is further moved in the insertion direction S, the pair of arms 721, 722 is elastically deformed to expand the gap therebetween. Then, the stress generated by the elastic deformation of the pair of arms 721, 722 pushes the contact projection 721a of the one arm 721 onto the slit 511. Then, as shown in FIG. 8B, the slit 511 of the electrode-insulating film 51A is expanded by the contact projection 721a, and the electrode 41 of the flat conductor 4 of the FFC 1A and the contact projection 721a contact each other and are electrically connected to each other. At this time, the electrode 41 is covered by the electrode-insulating film 51A except the contact area with the contact projection 721a.

As described above, according to the present invention, the FFC 1A as the flat circuit body having a plurality of electrodes 41 includes the electrode-insulating film 51A covering the surface of the electrode 41 other than the contact area with the terminal 72. Therefore, when a whisker is generated in the electrode 41 of the FFC 1A, the electrode-insulating film 51A prevents the whisker from extending to an adjacent electrode 41. Therefore, even when the electrode 41 is coated with a low-cost tin plating, the short-circuit caused by the whisker can be prevented.

Further, a process for electrically connecting the terminal 72 and the electrode 41 is processed in the electrode-insulating film 51A, the electrode 41 and the terminal 72 are surely electrically connected to each other.

Further, the slit 511 which the terminal 72 penetrates is provided on the electrode-insulating film 51A, the electrode 41 and the terminal 72 are surely electrically connected to each other by a simple processing.

### Third Embodiment

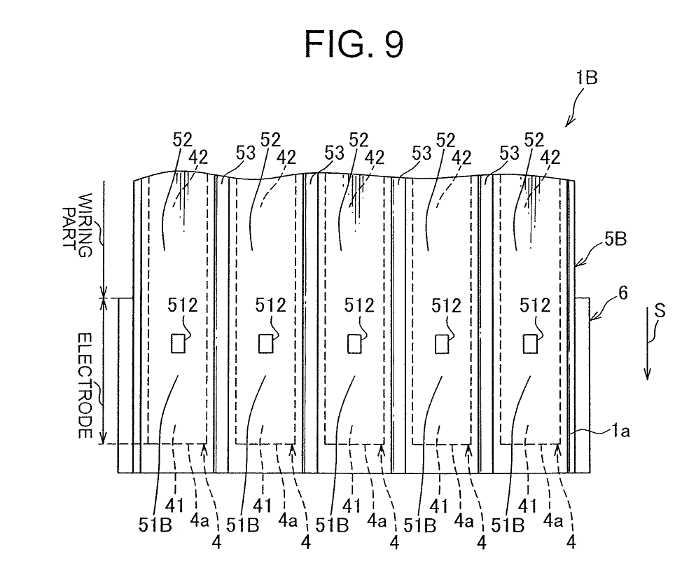

In the second embodiment described above, the FFC 1A has the slit 511 on the electrode-insulating film 51A. However, the present invention is not limited to this. For example, as shown in FIG. 9, an opening 512 for exposing the surface of the electrode 41 along an contact area with the contact projection 721a of the terminal 72 is provided on a electrode-insulating film 51B of an FFC 1B instead of the slit 511 in the second embodiment.

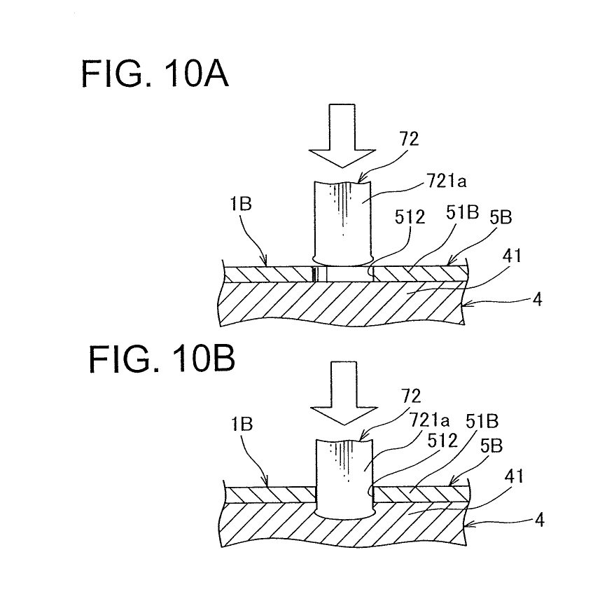

Next, an operation of the FFC 1B according to the present invention will be explained with reference to FIGS. 10A and 10B.

When such an FFC 1B is inserted into the connector 7 along the insertion direction S, firstly, the electrode-insulating film 51B and the reinforcing member 6 provided at the end 1a of the FFC 1B is positioned between the tip ends of the pair of arms 721, 722 of the terminal 72, and as shown in FIG. 10A, the opening 512 of the electrode-insulating film 51B and the contact projection 721a are arranged along the insertion direction S. Then, when the FFC 1B is further moved in the insertion direction S, the pair of arms 721, 722 is elastically deformed to expand the gap therebetween. Then, owing to the stress generated by the elastic deformation of the pair of arms 721, 722, the contact projection 721a of the one arm 721 enters the opening 512. Then, as shown in FIG. 10B, the contact projection 721a is fitted into the opening 512 of the electrode-insulating film 51B, and the electrode 41 of the flat conductor 4 of the FFC 1B and the contact projection 721a contact each other and are electrically connected to each other. At this time, the electrode 41 is covered by the electrode-insulating film 51B except the contact area with the contact projection 721a.

According to the above, because the opening 512 for exposing the surface of the electrode 41 along the contact area with the terminal 72 is provided on the electrode-insulating film 51B of the FFC 1B, the electrode 41 and the terminal 72 are surely electrically connected to each other by a simple processing. Further, the FFC 1B has the same effect as the second embodiment.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A flat circuit body comprising:
a plurality of flat electrodes arranged with gaps between them at an end of the flat circuit body and configured to contact terminals of a mating connector; and
an electrode-insulating film configured to cover a surface of the electrode other than a contact area with the terminal when the electrode contacts the terminal.

2. The flat circuit body as claimed in claim 1,
wherein the electrode-insulating film is formed in a manner to cover a whole surface of the electrode, and in a manner to be broken by the terminal when the terminal is pushed onto the electrode-insulating film.

3. The flat circuit body as claimed in claim 1,
wherein a process for electrically connecting the terminal and the electrode is processed in the electrode-insulating film.

4. The flat circuit body as claimed in claim 3,
wherein a slit through which the terminal penetrates is provided on the electrode-insulating film.

5. The flat circuit body as claimed in claim 3, wherein an opening where the surface of the electrode is exposed along a contact area between the electrode and the terminal is provided on the electrode-insulating film.
